(19) United States
(12) Patent Application Publication
(10) Pub. No.: US 2018/0295283 A1
(43) Pub. Date: Oct. 11, 2018

(54) MOBILE TERMINAL AND METHOD OF CONTROLLING THE SAME

(71) Applicant: LG ELECTRONICS INC., Seoul (KR)

(72) Inventor: Jungki KIM, Seoul (KR)

(73) Assignee: LG ELECTRONICS INC., Seoul (KR)

(21) Appl. No.: 15/657,015

(22) Filed: Jul. 21, 2017

(30) Foreign Application Priority Data
Apr. 6, 2017 (KR) 10-2017-0044562

(51) Int. Cl. H04N 5/232; H04N 5/247

(52) U.S. Cl. CPC H04N 5/23238; H04N 5/23222; H04N 5/247; H04N 5/23293

(57) ABSTRACT

Disclosed are a mobile terminal with a plurality of cameras and image photography control method for the same. The mobile terminal according to the present invention includes a first camera unit having a first angle of view, a second camera unit having a second angle of view; and a control unit, wherein the control unit is configured to obtain image data based on a first photography parameter for a first field of view (FOV) through the first camera unit, obtain a second photography parameter for a second FOV through the second camera unit, and obtain image data by changing the first photography parameter based on a comparison result between the obtained first and second photography parameters.

Pursuant to 35 U.S.C. § 119(a), this application claims the benefit of earlier filing date and right of priority to Korean Application No. 10-2017-0044562, filed on Apr. 6, 2017, the contents of which are hereby incorporated by reference herein in their entirety.

### BACKGROUND OF THE INVENTION

### Field of the Invention

The present invention relates to a mobile terminal and method of controlling the same, and more particularly, a camera sensor data processing method for a mobile terminal provided with or connected to a plurality of cameras.

### Discussion of the Related Art

Generally, terminals can be classified into mobile terminals and stationary terminals according to their mobility. As functions of the terminals are getting diversified, the terminals tend to be implemented as multimedia players with multiple functions of capturing images or videos, playing music files or video files, gaming, and receiving broadcasting programs, and the like. To support and increase the functionality of the terminal, the improvement of structural parts and/or software parts can be taken into account.

In the related art, a mobile terminal having a plurality of cameras needs to control the individual cameras to obtain an image. In addition, when a user captures panorama images using such a mobile terminal, the user cannot change parameter values, which are determined before starting the photography, until obtaining a final panorama image so that the user cannot handle an event that occurs during the photography. Moreover, the quality of the panorama images may also be degraded. To solve these problems, the panorama images may be corrected or adjusted using an editing tool after acquisition of the images. However, it may cause inconvenience to the user.

### SUMMARY OF THE INVENTION

Accordingly, embodiments of the present invention are directed to a mobile terminal and method of controlling the same that substantially obviate one or more problems due to limitations and disadvantages of the related art.

An object of the present invention is to provide a mobile terminal and method of controlling the same, by which when functions based on a camera unit are performed, relevant parameters can be corrected or adjusted to handle an event such as a problem occurring during a photography process rapidly or in real time before acquisition of a final image/picture, thereby obtaining a more natural image/picture.

Another object of the present invention is to provide a mobile terminal and method of controlling the same, by which, using a plurality of camera units, the quality of an image/picture can be improved, an event such as a problem occurring during a photography process can be handled in real time, and a separate editing process for the image/picture can be omitted, thereby improving usability and/or efficiency of the mobile terminal.

A further object of the present invention is to enhance product reliability by providing an image/picture with improved quality through a mobile terminal provided with or connected to a plurality of camera units.

It will be appreciated by persons skilled in the art that the objects that could be achieved with the present invention are not limited to what has been particularly described hereinabove and the above and other objects that the present invention could achieve will be more clearly understood from the following detailed description.

Hereinafter, disclosed are a mobile terminal and method of controlling the same.

To achieve these objects and other advantages and in accordance with the purpose of the invention, as embodied and broadly described herein, a mobile terminal according to the present invention may include a first camera unit having a first angle of view, a second camera unit having a second angle of view, and a control unit. In this case, the control unit may be configured to obtain image data based on a first photography parameter for a first field of view (FOV) through the first camera unit, obtain a second photography parameter for a second FOV through the second camera unit, and obtain image data by changing the first photography parameter based on a comparison result between the obtained first and second photography parameters.

In another aspect of the present invention, a mobile terminal according to the present invention may include a first camera unit having a first angle of view, a second camera unit having a second angle of view, and a control unit. In this case, the control unit may be configured to obtain data on a first field of view (FOV) from the first angle of view of the first camera unit, obtain data on a second FOV from the second angle of view of the second camera unit, compare the obtained data for the first and second FOVs, and change a photography parameter for a portion having different data when taking a photograph using the first or second camera unit.

It will be appreciated by persons skilled in the art that the solutions that can be achieved through the present invention are not limited to what has been particularly described hereinabove and other solutions of the present invention will be more clearly understood from the following detailed description.

Accordingly, the present invention provides the following effects and/or advantages.

According to at least one embodiment of the present invention, when functions based on a camera unit are performed, relevant parameters can be corrected or adjusted to handle an event such as a problem occurring during a photography process rapidly or in real time before acquisition of a final image/picture, thereby obtaining a more natural image/picture.

According to at least one embodiment of the present invention, using a plurality of camera units, the quality of an image/picture can be improved, an event such as a problem occurring during a photography process can be handled in real time, and a separate editing process for the image/picture can be omitted, thereby improving usability and/or efficiency of the mobile terminal.

According to at least one embodiment of the present invention, product reliability can be enhanced by providing an image/picture with improved quality through a mobile terminal provided with or connected to a plurality of camera units.

It will be appreciated by persons skilled in the art that the effects that can be achieved through the present invention are not limited to what has been particularly described hereinabove and other advantages of the present invention will be more clearly understood from the following detailed description.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1a is a block diagram of a mobile terminal according to one embodiment of the present invention;

FIGS. 1b and 1c are conceptual views of the mobile terminal of FIG. 1a, viewed from different directions;

FIG. 2 is a diagram illustrating a configuration of a mobile terminal according to another embodiment of the present invention;

FIG. 3 is a diagram illustrating a configuration of a mobile terminal according to a further embodiment of the present invention;

FIG. 4 is a rear perspective view of a mobile terminal with a plurality of cameras according to one embodiment of the present invention;

FIG. 5 is a block diagram illustrating camera sensors and components for data processing;

FIG. 6 is a flowchart for explaining a camera sensor data processing method for a mobile terminal according to one embodiment of the present invention;

FIG. 7 is a diagram illustrating an example of a panorama image;

FIGS. 8 to 10 are diagrams for explaining a panorama photography method according to one embodiment of the present invention;

FIG. 11 is a diagram for explaining a user interface (UI) provided for panorama photography according to one embodiment of the present invention;

FIG. 12 is a diagram for explaining a panorama photography method according to another embodiment of the present invention; and

FIG. 13 is a diagram for a camera sensor data processing method for a mobile terminal according to another embodiment of the present invention;

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a term such as “module” and “unit” may be used to refer to elements or components. Use of such a term herein is merely intended to facilitate description of the specification, and the term itself is not intended to give any special meaning or function. In the present invention, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present invention should be construed to extend to any alterations, equivalents and substitutes in addition to those which are particularly set out in the accompanying drawings.

It will be understood that although the terms first (1^{st}), second (2^{nd}), etc. may be used herein to describe various elements, and these elements should not be limited by these terms. These terms are generally only used to distinguish one element from another.

It will be understood that when an element is referred to as being “connected with” or “accessed by” another element, the element can be directly connected with or accessed by the other element or intervening elements may also be present. In contrast, when an element is referred to as being “directly connected with” or “directly accessed by” another element, there are no intervening elements present.

A singular representation may include a plural representation unless it represents a definitely different meaning from the context.

Terms such as “comprise”, “include” or “have” are used herein and should be understood that they are intended to indicate an existence of several components, functions or steps, disclosed in the specification, and it is also understood that greater or fewer components, functions, or steps may likewise be utilized. Moreover, due to the same reasons, it is also understood that the present application includes a combination of features, numerals, steps, operations, components, parts and the like partially omitted from the related or involved features, numerals, steps, operations, components and parts described using the aforementioned terms unless deviating from the intentions of the disclosed original invention.

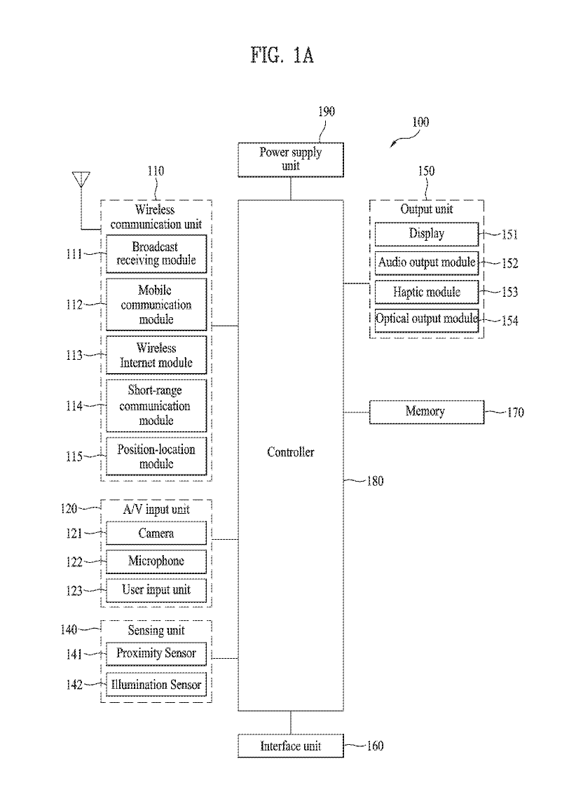

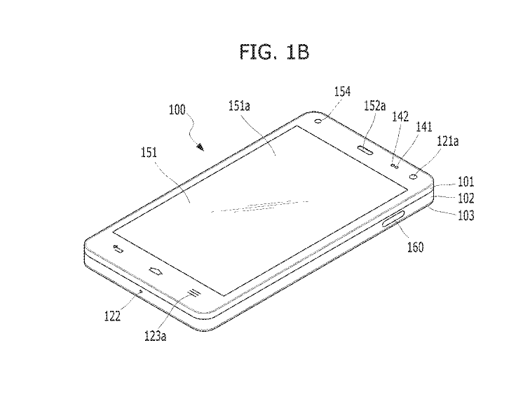

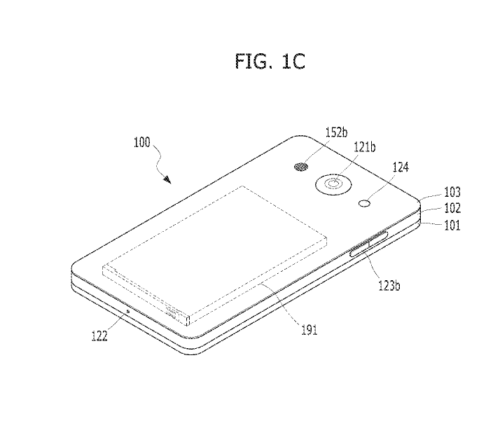

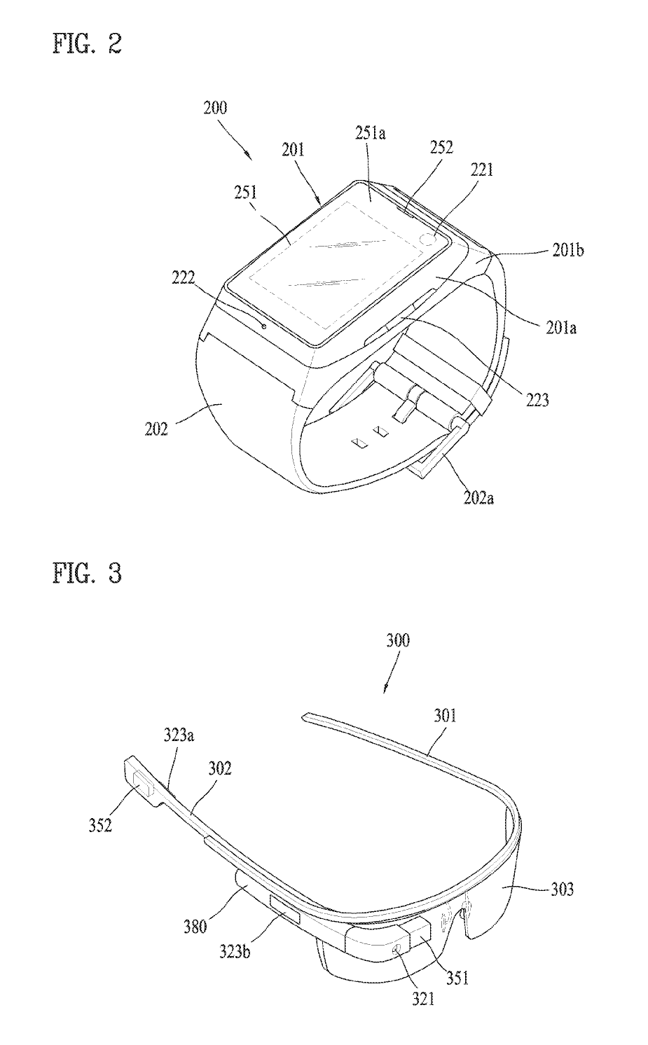

According to the present invention, a mobile terminal may include a smart phone shown in FIG. 1, a laptop computer, a digital broadcast terminal, a personal digital assistants (PDA), a portable multimedia player (PMP), a navigator, a slate PC, a tablet PC, a ultrabook, a wearable device (e.g., smart watch shown in FIG. 2), a smart glass shown in FIG. 3, a head mounted display (HMD), etc.

In this specification, a field of view (FOV) means a view or viewing angle that is captured or can be captured by each camera unit or camera lens provided with or connected to a mobile terminal. In addition, the FOV can be referred to as an angle of view or angle of view range. Although both of the FOV and angle of view relate to a viewing angle that can be captured by the camera unit or camera lens, they may have different meanings in some cases. In this specification, the angle of view is defined as a photographing angle of a camera unit or camera lens and the FOV is defined as a viewing angle or a viewing range of a scene be captured by the camera unit or camera lens. However, the terms can be interchangeably used in some cases.

Meanwhile, configurations according to the embodiments of the present invention can be applied to not only a mobile terminal but also a fixed terminal such as a digital TV, a desktop computer, a digital signage, etc.

The mobile terminal according one embodiment of the present invention may include a first camera unit having a first angle of view, a second camera unit having a second angle of view, and a processor. In this case, the processor may be configured to obtain image data based on a first photography parameter for a first field of view (FOV) through the first camera unit, obtain a second photography parameter for a second FOV through the second camera unit, obtain image data by changing the first photography parameter based on a comparison result between the obtained first and second photography parameters.

FIG. 1a is a block diagram of a mobile terminal according to the present invention and FIGS. 1b and 1c are conceptual views of the mobile terminal according to the present invention, viewed from different directions.

Referring to FIG. 1a, the mobile terminal 100 may include components such as a wireless communication unit 110, an input unit 120, a sensing unit 140, an output unit 150, an interface unit 160, a memory 170, a controller 180, a power supply unit 190, etc. It should be noted that all components illustrated in FIG. 1a are not mandatory and thus, the number of components included in the mobile terminal according to the present invention may be more or fewer than the above-listed components.

The wireless communication unit 110 typically includes one or more modules which permit communications such as wireless communications between the mobile terminal 100 and a wireless communication system, communications between the mobile terminal 100 and another mobile terminal 100, communications between the mobile terminal 100 and an external server. Further, the wireless communication unit 110 typically includes one or more modules which connect the mobile terminal 100 to one or more networks.

The wireless communication unit 110 may include at least one of a broadcast receiving module 111, a mobile communication module 112, a wireless Internet module 113, a short-range communication module 114, and a location information module 115.

The input unit 120 may include a camera 121 for an image or video signal input, a microphone 122 (or an audio input unit) for an audio signal input, and a user input unit 123 (e.g., a touch key, a push key (or mechanical key), etc.) for receiving an input of information from a user. Audio or image data collected by the input unit 20 may be analyzed and processed into user's control command

The sensing unit 140 is typically implemented using one or more sensors configured to sense internal information of the mobile terminal 100, information on the surrounding environment of the mobile terminal 100, user information, and the like. For example, the sensing unit 140 may include a proximity sensor 141 and an illumination sensor 142. If desired, the sensing unit 14 may alternatively or additionally include other types of sensors or devices, such as a touch sensor, an acceleration sensor, a magnetic sensor, a gravity sensor (G-sensor), a gyroscope sensor, a motion sensor, an RGB sensor, an infrared (IR) sensor, a finger scan sensor, a ultrasonic sensor, an optical sensor (for example, the camera 121), the microphone 122, a battery gauge, an environment sensor (for example, a barometer, a hygrometer, a thermometer, a radiation detection sensor, a thermal sensor, and a gas sensor, etc.), and a chemical sensor (for example, an electronic nose, a health care sensor, a biometric authentication sensor, etc.), to name a few. The mobile terminal 100 disclosed in the present specification may be configured to utilize information obtained from at least two of the above-listed sensors.

The output unit 150 is typically configured to output various types of information, such as audio, video, tactile output, and the like. The output unit 150 may include at least one of a display unit 151, an audio output unit 152, a haptic module 153, and an optical output unit 154. The display unit 151 may have an inter-layered structure or an integrated structure with a touch sensor in order to facilitate a touchscreen. The touchscreen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include at least one of wired or wireless headset ports, external power supply ports, wired or wireless data ports, memory card ports, ports for connecting a device having an identification module, audio input/output (I/O) ports, video I/O ports, earphone ports, and the like. In some cases, the mobile terminal 100 may perform appropriate control functions associated with a connected external device, in response to the external device being connected to the interface unit 160.

The memory 170 is configured to store data for supporting various functions of the mobile terminal 100. Specifically, the memory 170 stores data to support various functions or features of the mobile terminal 100. For instance, the memory 170 may be configured to store application programs executed in the mobile terminal 100, data or commands for operations of the mobile terminal 100, and the like. Some of these application programs may be downloaded from an external server via wireless communication.

In addition, other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 controls overall operations of the mobile terminal 100, in addition to the operations associated with the application programs. The controller 180 may provide or process information or functions appropriate for a user by processing signals, data, information and the like, which are inputted or outputted by the various components depicted in the above description, or running application programs stored in the memory 170.

Moreover, in order to launch an application program stored in the memory 170, the controller 180 can control at least one of the components described with reference to FIG. 1a. Furthermore, the controller 180 controls at least two of the components included in the mobile terminal 100 to launch the application program.

The power supply unit 190 can be configured to receive external power or provide internal power in order to supply appropriate power required for operating elements and components included in the mobile terminal 100. The power supply unit 190 may include a battery. In particular, the battery may include be a built-in battery or a replaceable (or detachable) battery.

At least some of the components can operate cooperatively to implement the operations, controls or controlling methods of the mobile terminal 100 according to various embodiments mentioned in the following description. In addition, the operation, control or controlling method of the mobile terminal 100 may be implemented on the mobile terminal 100 by launching at least one application program stored in the memory 170.

Referring to FIGS. 1b and 1c, the mobile terminal 100 disclosed herein is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal. However, such teachings with regard to a particular type of mobile terminal will generally apply to other types of mobile terminals as well.

Here, considering the mobile terminal 100 as at least one assembly, the terminal body may be understood as a conception referring to the assembly.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 may be disposed on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery, an identification module, a memory card, and the like. A rear cover 103 is configured to cover the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output unit 152b.

The cases 101, 102, 103 may be formed by injection-molding synthetic resin or may be formed of a metal, for example, stainless steel (STS), aluminum (Al), titanium (Ti), or the like.

Unlike the example in which a plurality of cases form an inner space for accommodating components, the mobile terminal 100 may be configured such that one case forms the inner space. In this case, the mobile terminal 100 can be implemented to have a uni-body such that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include the display unit 151, a first audio output unit 152a, the second audio output unit 152b, the proximity sensor 141, the illumination sensor 142, the optical output unit 154, first and second cameras 121a and 121b, first and second manipulation units 123a and 123b, the microphone 122, the interface unit 160, and the like.

Hereinafter, as illustrated in FIGS. 1b and 1c, a description will be given of the exemplary mobile terminal 100 in which the display unit 151, the first audio output unit 152a, the proximity sensor 141, the illumination sensor 142, the optical output unit 154, the first camera 121a, and the first manipulation unit 123a are disposed on the front surface of the terminal body, the second manipulation unit 123b, the microphone 122, and the interface unit 160, are disposed on the side surface of the terminal body, and the second audio output unit 152b and the second camera 121b are supposed on the rear surface of the terminal body.

However, those components may not be limited to the arrangement. Some components may be omitted or rearranged or located on different surfaces. For example, the first manipulation unit 123a may not be located on the front surface of the terminal body, and the second audio output unit 152b may be located on the side surface of the terminal body other than the rear surface of the terminal body.

The display unit 151 outputs (displays) information processed in the mobile terminal 100. For example, the display unit 151 may display execution screen information of an application program launched in the mobile terminal 100 or user interface (UI) and graphic user interface (GUI) information in accordance with the execution screen information.

The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180 may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (cf. FIG. 1a). In some cases, the touch screen may replace at least some of the functions of the first manipulation unit 123a.

The first audio output unit 152a may be implemented in the form of a receiver for transferring call sounds to a user's ear and the second audio output unit 152b may be implemented in the form of a loud speaker to output alarm sounds, multimedia playback sounds, and the like.

The window 151a of the display unit 151 will typically include a sound hole for emitting sounds generated by the first audio output unit 152a. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output unit 154 can be configured to output light for indicating an event generation. Examples of such events include message reception, call signal reception, missed call, alarm, schedule alarm, email reception, information reception through an application, and the like. When a user has checked a generated event, the controller 180 can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide an input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

Although in the drawing, the first manipulation unit 123a is illustrated as a touch key, the present invention is not limited thereto. For example, the first manipulation unit 123a can be implemented with a push key, a touch key, and combinations thereof.

Inputs received through the first and second manipulation units 123a and 123b may be used in various ways. For example, the first manipulation unit 123a may receive commands such as menu, home key, cancel, search, and the like from the user, and the second manipulation unit 123b may receive commands such as a command for controlling a volume level outputted from the first or second audio output unit 152a or 152b, a command for switching to a touch recognition mode of the display unit 151, and the like.

As another example of the user input unit 123, a rear input unit (not shown) may be disposed on the rear surface of the terminal body. The rear input unit can be manipulated by a user to provide an input to the mobile terminal 100. The input may be used in a variety of different ways. For example, the rear input unit may be used by the user to provide an input for power on/off, start, end, scroll, control volume level outputted from the first or second audio output unit 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

When the rear input unit is disposed on the rear surface of the terminal body, a new type of user interface using this can be implemented. When the aforementioned touch screen or rear input unit is disposed on the front surface of the terminal body, it can replace some or all of the functionality of the first manipulation unit 123a. As such, in situations where the first manipulation unit 123a is omitted from the front side, the display unit 151 can have a larger screen.

As a further alternative, the mobile terminal 100 may include a finger recognition sensor which scans a user's fingerprint. The controller 180 can then use fingerprint information sensed by the finger recognition sensor as part of an authentication procedure. The finger recognition sensor may also be installed in the display unit 151 or implemented in the user input unit 123.

The microphone 122 is configured to receive user's voices and other extra sounds. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b may be disposed on the rear side of the terminal body and have an image capturing direction that is substantially opposite to the image capturing direction of the first camera unit 121a.

The second camera 121b may include a plurality of lenses arranged along at least one line. A plurality of the lenses may be also arranged in a matrix configuration. This camera may be called an “array camera.” When the second camera 121b is configured with an array camera, images may be captured in various manners using a plurality of lenses and images with better qualities can be obtained.

A flash 124 may be disposed adjacent to the second camera 121b. When an image of a subject is captured by the second camera 121b, the flash 124 may apply light toward the subject.

The second audio output unit 152b can be located on the terminal body. The second audio output unit 152b may implement stereophonic sound functions in conjunction with the first audio output unit 152a, and may be also used for implementing a speaker phone mode for call communication.

At least one antenna for wireless communication may be located on the terminal body. The antenna may be installed in the terminal body or formed in the case. For example, an antenna which configures a part of the broadcast receiving module 111 (cf. FIG. 1a) may be retractable into the terminal body. Alternatively, an antenna may be formed using a film attached to an inner surface of the rear cover 103, or a case containing a conductive material may be configured to play a role as an antenna.

The power supply unit 190 (cf. FIG. 1a) for supplying power to the mobile terminal 100 may be provided to the terminal body. In addition, the power supply unit 190 may include a battery 191 configured externally detachable from the body.

The battery 191 may be configured to receive power via a power source cable connected to the interface unit 160. In addition, the battery 191 can be wirelessly recharged through a wireless charger. The wireless charging may be implemented by magnetic induction or resonance (e.g., electromagnetic resonance).

In the present drawing, the rear cover 103 is coupled to the rear case 102 for shielding the battery 191, to prevent separation of the battery 191 and to protect the battery 191 from an external impact or foreign particles. If the battery 191 is configured to be detachable from the terminal body, the rear case 103 can be detachably coupled to the rear case 102.

Meanwhile, an accessory for protecting an appearance or assisting or extending the functions of the mobile terminal 100 can also be included in the mobile terminal 100. For example, the accessory may include a cover or pouch for covering or accommodating at least one surface of the mobile terminal 100. The cover or pouch may be configured to extend functionality of the mobile terminal 100 by interworking with the display unit 151. For another example, the accessory may include a touch pen for assisting or extending a touch input to a touchscreen.

FIG. 2 is a perspective view illustrating an example of a watch-type mobile terminal 200 according to another embodiment of the present invention.

Referring to FIG. 2, the watch-type mobile terminal 200 includes a main body 201 with a display unit 251 and a band 202 connected to the main body 201 to be wearable on a wrist. In general, the mobile terminal 200 may have the same or similar features as those of the mobile terminal 100 of FIGS. 1a to 1c.

The main body 201 may include a case having a certain appearance. As illustrated, the case may include a first case 201a and a second case 201b cooperatively defining an inner space for accommodating various electronic components. However, the present invention is not limited thereto. For instance, a single case may alternatively be implemented, with such a case being configured to define the inner space, thereby implementing a mobile terminal 200 with a uni-body.

The watch-type mobile terminal 200 can be configured to perform wireless communication, and an antenna for the wireless communication can be installed in the main body 201. The antenna may extend its function using the case. For example, a case including a conductive material may be electrically connected to the antenna to extend a ground area or a radiation area.

The display unit 251 may be disposed on the front surface of the main body 201 so that displayed information is viewable to a user. In some embodiments, the display unit 251 includes a touch sensor so that the display unit can function as a touch screen. As illustrated, a window 251a is positioned on the first case 201a to form a front surface of the terminal body together with the first case 201a.

An audio output unit 252, a camera 221, a microphone 222, and a user input unit 223 can be disposed on the main body 201. When the display unit 251 is implemented as the touch screen, the display unit 251 can function as the user input unit 223. Thus, additional function keys may not be provided to the main body 201.

The band 202 is commonly worn on the user's wrist and may be made of a flexible material for facilitating wearing of the device. As one example, the band 202 may be made of leather, rubber, silicon, synthetic resin, or the like. The band 202 may also be configured to be detachable from the main body 201. Accordingly, the band 202 may be replaceable with various types of bands according to a user's preference.

In some cases, the band 202 may be used for extending the performance of the antenna. For example, the band may include therein a ground extending portion (not shown) electrically connected to the antenna to extend a ground area.

The band 202 may include a fastener 202a. The fastener 202a may be implemented into a buckle type, a snap-fit hook structure, a Velcro® type, or the like, and include a flexible section or material. The drawing illustrates an example in which the fastener 202a is implemented using a buckle.

FIG. 3 is a perspective view illustrating an example of a glasses-type mobile terminal 300 according to a further embodiment of the present invention.

The glasses-type mobile terminal 300 can be wearable on a head of a human body and provided with a frame (case, housing, etc.) therefor. The frame may be made of a flexible material to be easily worn. FIG. 3 shows that the frame includes a first frame 301 and a second frame 302, which can be made of different materials. In general, mobile terminal 30 may have the same or different features as those of the mobile terminal 100 of FIGS. 1a to 1c.

The frame may be supported on the head and defines a space for mounting various components. As illustrated, electronic components, such as a control module 380, an audio output module 352, and the like, may be mounted to the frame part. Also, a lens 303 for covering either or both of the left and right eyes may be detachably coupled to the frame part.

The control module 380 is configured to control various electronic components included in the mobile terminal 300. The control module 380 may be understood as a component corresponding to the aforementioned controller 180. FIG. 3 illustrates that the control module 380 is installed in the frame part on one side of the head, but other locations are possible.

The display unit 351 may be implemented as a head mounted display (HMD). The HMD refers to display techniques by which a display is mounted on a head to show an image directly in front of a user's eyes. In order to provide an image directly in front of the user's eyes when the user wears the glasses-type mobile terminal 300, the display unit 351 may be located to either or both of the left and right eyes. FIG. 3 illustrates that the display unit 351 is located on a portion corresponding to the right eye to output an image viewable by the user's right eye.

The display unit 351 may be configured to project an image on the user's eye using a prism. Also, the prism may be made of an optically transparent material such that the user can view both the projected image and a general visual field (a range that the user views through the eyes) in front of the user.

In this way, the image outputted through the display unit 351 may be viewed while overlapping with the general visual field. The mobile terminal 300 may provide an augmented reality (AR) by overlaying a virtual image with a realistic image or background using the display.

The camera 321 may be disposed adjacent to either or both of the left and right eyes to capture an image. Since the camera 321 is located adjacent to the eye, the camera 321 can acquire a scene that the user is currently viewing.

Although FIG. 3 shows that the camera 321 is disposed on the control module 380, the present invention is not limited thereto. For example, the camera 321 may be installed in the frame part and also, a plurality of cameras may be used to acquire a stereoscopic image.

The glasses-type mobile terminal 300 may include user input units 323a and 323b, which can be manipulated by the user to provide an input. The user input units 323a and 323b may employ any techniques which allow the user to input in a tactile manner For example, typical tactile inputs include touch, push, and the like. FIG. 3 shows that the user input units 323a and 323b, which operate in a pushing manner and a touching manner, are disposed on the frame part and the control module 380, respectively.

If desired, the mobile terminal 300 may include a microphone (not shown) for receiving a sound input and converting the sound input into electrical audio data and an audio output module 352 for outputting the audio data. The audio output module 352 may be configured to produce a sound in a general sound output manner or a bone conduction manner. When the audio output module 352 is implemented in the bone conduction manner and the user wears the mobile terminal 300, the audio output module 352 may be closely adhered to the head and vibrate the user's skull to transfer sounds.

Hereinafter, a description will be given of a communication system for the mobile terminal according to the present invention

First, the communication system may use different wireless interfaces and/or physical layers. For example, the wireless interfaces may include frequency division multiple access (FDMA), time division multiple access (TDMA), code division multiple access (CDMA), universal mobile telecommunications system (UMTS) (particularly, LTE and LTE-A), global system for mobile communications (GSM), and the like.

Hereinafter, for convenience of description, the present invention will be described based on the CDMA. However, it is apparent that the present invention can be also applicable to all communication systems including the CDMA wireless communication system.

The CDMA wireless communication system may include at least one terminal 100, at least one base station (BS) (referred to as a Node B or an evolved Node B), at least one base station controller (BSC), and a mobile switching center (MSC). The MSC is configured to connect to a Public Switched Telephone Network (PSTN) and BSCs. The BSCs can be respectively connected to BSs via backhaul lines. For the backhaul lines, at least one of E1/T1, ATM, IP, PPP, Frame Relay, HDSL, ADSL, and xDSL can be used. That is, the CDMA wireless communication system may include a plurality of BSCs.

Each of the plurality of BSs may include at least one sector and each sector may include an omnidirectional antenna or an antenna indicating a particular radial direction from the BS. Alternatively, each sector may include two or more antennas with various forms. Each of the BSs may be configured to support a plurality of frequency assignments and each frequency assignment has a particular spectrum (for example, 1.25 MHz, 5 MHz, etc.).

An intersection of the sector and frequency assignment can be referred to as a CDMA channel The BS may be referred to as base station transceiver subsystems (BTSs). In this case, the term “base station” may collectively refer to a BSC and at least one BS. The BS may also indicate “cell site”. Alternatively, individual sectors for a specific BS may also be referred to as a plurality of cell sites.

A broadcasting transmitter (BT) may transmit broadcasting signals to mobile terminals operating within the system. The broadcast receiving module 111 shown in FIG. 1a may be included in the mobile terminal 100 to receive broadcast signals transmitted by the BT.

In addition, the CDMA wireless communication system may be linked to a global positioning system (GPS) for checking a location of the mobile terminal 100. In this case, a satellite can be used to obtain the location of the mobile terminal 100. To obtain valid location information, two or more satellites can be used. However, in some cases, less than two satellites may be used. Here, the positioning of the mobile terminal 100 may be carried out by using every positioning technology as well as the GPS positioning technology. Also, at least one of the GPS satellites may alternatively or additionally be configured to provide satellite DMB transmissions.

The location information module 115 is generally configured to detect, calculate, derive or otherwise identify the location of the mobile terminal. For example, the location information module 115 includes a Global Position System (GPS) module, a Wi-Fi module or both. If desired, the location information module 115 may alternatively or additionally function with any of the other modules of the wireless communication unit 110 to obtain data related to the location of the mobile terminal.

A typical GPS module 115 may measure an accurate time and distance from three or more satellites, and accurately calculate a current three-dimensional location of the mobile terminal, which contains the current latitude, longitude and altitude, by applying the trigonometry to the measured time and distance information. Recently, a method of acquiring distance and time information from three satellites and performing error correction using another single satellite has been widely used. In addition, the GPS module 115 may also calculate speed information by measuring the current location in real time. Sometimes, accuracy of a measured position may be compromised when the mobile terminal is located in a blind spot of satellite signals, such as being located in an indoor space. In order to minimize the effect of such blind spots, an alternative or supplemental location technique, such as Wi-Fi Positioning System (WPS), may be utilized.

The Wi-Fi positioning system (WPS) refers to a WLAN-based location determination technology using Wi-Fi as a technology for tracking the location of the mobile terminal 100. This technology typically includes the use of a Wi-Fi module in the mobile terminal 100 and a wireless access point (AP) for communicating with the Wi-Fi module.

The Wi-Fi positioning system may include a Wi-Fi location determination server, a mobile terminal, a wireless access point (AP) connected to the mobile terminal, and a database stored with wireless AP information.

The mobile terminal 100 connected to the wireless AP may transmit a location information request message to the Wi-Fi location determination server.

The Wi-Fi location determination server extracts information of the wireless AP connected to the mobile terminal 100, based on the location information request message (or signal) of the mobile terminal 100. The information of the wireless AP may be transmitted to the Wi-Fi location determination server through the mobile terminal 100, or may be transmitted to the Wi-Fi location determination server from the wireless AP.

The information of the wireless AP extracted based on the location information request message of the mobile terminal 100 may include one or more of media access control (MAC) address, service set identification (SSID), received signal strength indicator (RSSI), reference signal received power (RSRP), reference signal received quality (RSRQ), channel information, privacy, network type, signal strength, noise strength, and the like.

The Wi-Fi location determination server may receive the information of the wireless AP connected to the mobile terminal 100 as described above, and may extract wireless AP information corresponding to the wireless AP connected to the mobile terminal from the pre-established database. The information of any wireless APs stored in the database may be information such as MAC address, SSID, RSSI, channel information, privacy, network type, latitude and longitude coordinate of the wireless AP, building at which the wireless AP is located, floor number, detailed indoor location information (GPS coordinate available), AP owner's address, phone number, and the like. In order to remove wireless APs provided using a mobile AP or an illegal MAC address during a location determining process, the Wi-Fi location determination server may extract only the predetermined number of wireless AP information in order of high RSSI.

The Wi-Fi location determination server may extract (analyze) location information of the mobile terminal 100 using at least one wireless AP information extracted from the database. In particular, the Wi-Fi location determination server may compare the information with the received wireless AP information to extract (analyze) the location information of the mobile terminal 100.

A method for extracting (analyzing) location information of the mobile terminal 100 may include a cell-ID method, a fingerprint method, a trigonometry method, a landmark method, and the like.

According to the cell-ID method, based on peripheral wireless AP information collected by a mobile terminal, a location of a wireless AP having the largest signal strength is determined as a location of the mobile terminal. The cell-ID method is advantageous in that it can be simply implemented, it does not require additional costs, and location information can be rapidly acquired. However, if wireless APs are not densely installed, the accuracy of the positioning may be degraded.

According to the fingerprint method, signal strength information is collected by selecting a reference position from a service area and a location of a mobile terminal is calculated using the signal strength information transmitted from the mobile terminal based on the collected information. To use the fingerprint method, propagation characteristics need to be data-based in advance.

According to the trigonometry method, a location of a mobile terminal is calculated based on a distance between coordinates of at least three wireless APs and the mobile terminal. In order to measure the distance between the mobile terminal and the wireless APs, signal strength may be converted into distance information. Alternatively,

Time of Arrival (ToA), Time Difference of Arrival (TDoA), Angle of Arrival (AoA), or the like may be used.

According to the landmark method, a location of a mobile terminal is measured using a known landmark transmitter.

In addition to these position location methods, various algorithms may be used to extract (analyze) location information of a mobile terminal.

Such extracted location information may be transmitted to the mobile terminal 100 through the Wi-Fi location determination server and thus, the mobile terminal 100 can obtain the location information.

The mobile terminal 100 can acquire the location information by connecting to at least one wireless AP. The number of wireless APs necessary for the mobile terminal 100 to acquire the location information may be variously changed according to a wireless communication environment of the mobile terminal 100.

As described above with reference to FIG. 1a, short-range communication techniques such as Bluetooth, RFID, IrDA, UWB, ZigBee, NFC, Wireless USB, etc. can be applied to the mobile terminal according to the present invention.

A typical NFC module included in the mobile terminal supports non-contacting short-range wireless communication, which is performed between mobile terminals apart from each other by about 10 cm. The NFC module may operate in one of a card mode, a reader mode, and a P2P mode. The mobile terminal 100 may further include a security module for storing card information in order to operate the NFC module in the card mode. The security module may be a physical medium such as Universal Integrated Circuit Card (UICC) (e.g., a Subscriber Identification Module (SIM) or Universal SIM (USIM)), a secure micro SD and a sticker, or a logical medium (e.g., embedded Secure Element (SE)) embedded in the mobile terminal. In addition, data can be exchanged between the NFC module and the security module based on the Single Wire Protocol (SWP).

When the NFC module operates in the card mode, the mobile terminal may transmit card information to the outside like the typical ID card. Specifically, if a mobile terminal having information on a payment card (e.g, a credit card or a bus card) approaches a card reader, a short-range mobile payment may be executed. As another example, if a mobile terminal which stores information on an entrance card approaches an entrance card reader, an entrance approval procedure may start. In this case, a credit card, a traffic card, or an entrance card may be included in the security module in the form of applet, and the security module may store card information on the card mounted therein. Information on a payment card may include at least one of a card number, a remaining amount, a usage history, etc. Information on an entrance card may include at least one of a user's name, a user's number (e.g., undergraduate number or staff number), an entrance history, etc.

When the NFC module operates in the reader mode, the mobile terminal can read data from an external tag. The data received from the external tag by the mobile terminal may be coded into an NFC data exchange format defined by the NFC Forum. The NFC Forum generally defines four record types. Specifically, the NFC Forum defines four record type definitions (RTDs): smart poster, text, uniform resource identifier (URI), and general control. If the data received from the external tag is a smart poster type, the controller may execute a browser (e.g., Internet browser). If the data received from the external tag is a text type, the controller may execute a text viewer. If the data received from the external tag is a URI type, the controller may execute a browser or make a call. If the data received from the external tag is a general control type, the controller may execute a proper operation according to control content.

When the NFC module operates in the P2P (Peer-to-Peer) mode, the mobile terminal can execute P2P communication with another mobile terminal. In this case, a logical link control protocol (LLCP) can be applied to the P2P communication. For the P2P communication, a connection may be established between the mobile terminal and another mobile terminal. This connection may be categorized into a connectionless mode which ends after one packet is exchanged, and a connection-oriented mode in which packets are continuously exchanged. In addition, not only data such as an electronic type name card, a contact address, a digital photo and a URL, but also a setup parameter for Bluetooth connection and Wi-Fi connection can be exchanged for the P2P communication. Moreover, since an available distance for NFC communication is relatively short, the P2P mode can be effectively utilized in exchanging small size of data.

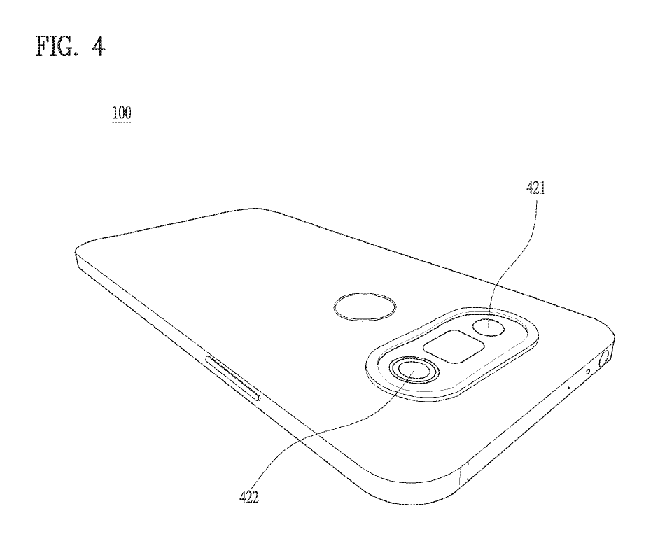

FIG. 4 is a rear perspective view of a mobile terminal with a plurality of cameras according to one embodiment of the present invention.

In general, a touch screen and display are disposed on the front surface of the mobile terminal 100, whereas at least one of one or more cameras, a function button, and a power on/off button is disposed on the rear surface of the mobile terminal. However, at least one of the function button and the power on/off button may be disposed on the side surface of the mobile terminal 100 rather than the rear surface. However, the above-described configuration is merely exemplary and the present invention is not limited to the configuration, structure, or arrangement.

FIG. 4 shows a case in which a first camera 421 and a second camera 422 are disposed on the rear surface of the mobile terminal 100.

The first and second cameras 421 and 422 may be disposed by being spaced apart from each other by a predetermined distance. In this case, if a user simultaneously uses the two cameras 421 and 422 spaced apart from each other by the predetermined distance as shown in FIG. 4, the user may obtain different images for the same subject.

The two cameras 421 and 422 may have different pixels, angles of view, view angles, etc. For example, the first camera 421 may have a narrow angle of view or a normal or standard angle of view and the second camera may have a wide angle of view, and vice versa. Hereinafter, the invention will be described on the premise that the first camera 421 has the narrow or standard angle of view and the second camera 422 has the wide angle of view.

Meanwhile, in this specification, an angle of view may mean horizontal and vertical viewing angles of a camera sensor. However, it is apparent that when a different term is used for the same or similar meaning, it belongs to the scope of the present invention.

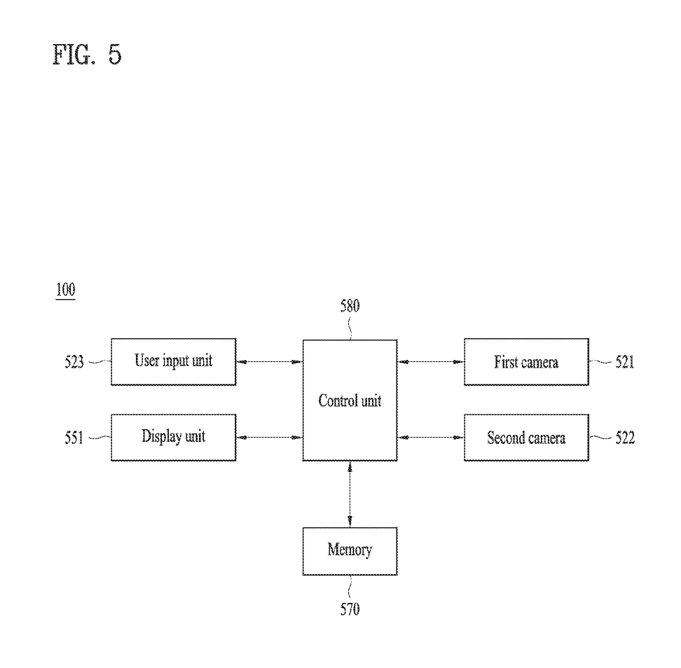

FIG. 5 is a block diagram illustrating camera sensors and components for data processing.

First and second cameras 521 and 522 can have different pixels and angles of view as described above with reference to FIG. 4. Although FIG. 4 shows that the first and second cameras are disposed on the rear surface of the terminal, the first and second cameras can be disposed on the front surface of the terminal.

A user input unit 523 may be configured to receive signals for obtaining first and second images. The signal for image acquisition is generated by a physical button (not shown) disposed on the mobile terminal 100 or a touch input. When the signal for image acquisition is generated by a touch input through a photography button displayed on the display unit, the user input unit 523 and a display unit 551 may be integrated as a single module. Meanwhile, the image acquisition can be interpreted as that an image is captured by a camera.

The display unit 551 may be configured to display an image previewed through the first or second camera. In addition, the display unit 551 may display a photography button for obtaining an image together with the preview image.

A memory may be configured to store images obtained through the first and second cameras 521 and 522.

A control unit 580 may be configured to be coupled to the first and second cameras 521 and 522, the user input unit 523, the display unit 551, and the memory 570 and control each of them. In this case, the control unit 580 may correspond to the aforementioned controller 180 of FIG. 1a.

For further understanding of the present invention and clarity of description, assume that a camera application is executed in the terminal or a camera sensor is turned on. In addition, assume that a camera-related function of the terminal is set to a panorama function. However, this is merely exemplary and the invention is not limited thereto.

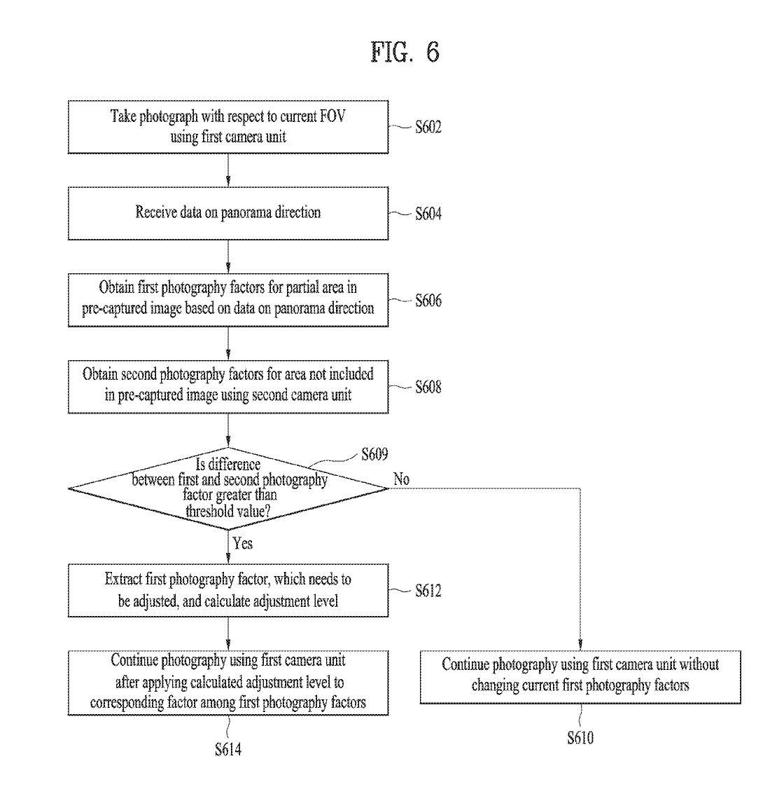

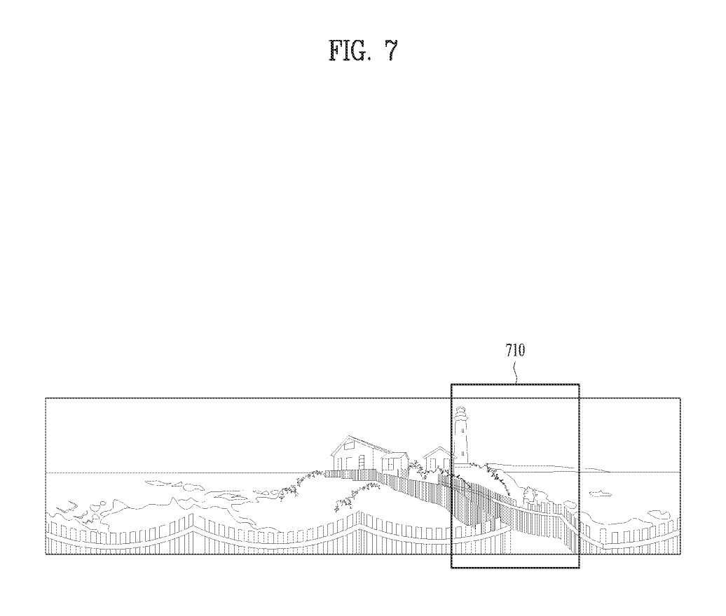

FIG. 6 is a flowchart for explaining a camera sensor data processing method for a mobile terminal according to one embodiment of the present invention and FIG. 7 is a diagram illustrating an example of a panorama image.

The terminal takes a photograph with respect to the current FOV using the first camera unit [S602]. In this case, if the panorama function is activated before an image is captured through the first camera unit, a guide for panorama photography is provided on the bottom of the display unit. According to the panorama guide provided in the terminal, a user needs to capture a panorama image by moving the terminal in a certain direction among up, down, left and right directions. That is, after taking the photograph with respect to the current FOV in the step S602, the terminal receives data on a panorama direction [S604].

Based on the data on the panorama direction received in the step S604, the terminal obtains a first photography parameter for the pre-captured image [S606]. In this case, for example, the obtained first photography parameter may for a partial or entire area of the pre-captured image. Alternatively, the first photography parameter may be an average in the corresponding area.

Here, the first photography parameter may include at least one parameter among all parameters required to capture an image through a camera unit. For example, the photography parameter may include exposure data, brightness data, shutter speed data, ISO data, focus data, zoom-in/zoom-out data, etc. Although it is assumed that the first photography parameter includes only the exposure data and the brightness data for understanding of the present invention and clarity of description, the invention is not limited thereto.

The terminal obtains a second photography parameter with reference to an FOV based on its angle of view using the second camera unit [S608]. In this case, the second camera unit performs operation for obtaining the second photography parameter when the first camera unit takes a photograph with reference to the FOV based on its angle of view. Meanwhile, the FOV of the first camera unit may be different from that of the second camera unit due to a difference between their angles of view. For example, the first camera unit may have the narrow or standard angle of view, whereas the second camera unit may have the wide angle of view as described above. Thus, when images are photographed by the first and second camera units, the FOV of the second camera unit may be greater than that of the second camera unit. In other words, after a first image is captured with respect to the FOV of the first camera unit using the first camera unit, the first photography parameter can be obtained based on at least a part of the first image, and at the same time or thereafter, the second photography parameter for a second image (in this case, the second image may be a virtual image) can be obtained using the second camera unit. The second photography parameter may be a photography parameter for an area in which the first and second images do not overlap with each other due to the FOV difference. For example, after obtaining the first photography parameter for the partial area of the image obtained by the first camera unit, the terminal can obtain the second photography parameter for the area where the first and second images do not overlap with each other in the progressing direction with reference to the data on the panorama direction received in the step S604.

By comparing the first and second photography parameters, the terminal determines whether a difference therebetween is greater than a threshold value [S609].

As shown in FIG. 7, a normal panorama image is generated such that all areas of the image are captured in the right or left direction based on a constant photography parameter, which is created with reference to the initial FOV. Thus, during the capturing process, a partial area of the image may be distorted due to a camera unit or external environment. Therefore, the aforementioned step needs to be performed.

FIG. 7 shows an example of photographing a panorama image by moving the camera unit from the left to the right according to guide data displayed on the terminal In the left side of the panorama image, the land is shown together with the grass. However, as it moves to the right, the sea is shown beyond the boundary between the sea and land. If the terminal uses a single FOV, there is no problem because the image can be adjusted (modified or corrected) for each FOV or the photography parameter can also be adjusted. In addition, such a problem may not or cannot be recognized due to the FOV. However, as shown in FIG. 7, brightness at the boundary 710 may be different from that of other areas. That is, when the final panorama image is watched, such a difference may be easily detected and overall reliability of the panorama function may also be degraded. To solve these problems, the final panorama image can be edited based on an average photography parameter value calculated with respect to the entire image. However, it may affect not only the boundary 710 but also other areas, thereby degrading the quality of the panorama image or completely changing the panorama image.

Therefore, the object of the present invention is to provide a mobile terminal with at least two camera units for improving a quality of a panorama image. Particularly, in case each camera unit has a different angle of view or covers a different FOV and a panorama function is activated, it is possible to obtain a photography parameter for the panorama direction using a camera unit rather than the main camera unit used to obtain the panorama image in advance. In addition, the obtained photography parameter can be reflected in real time while a photograph is taken, thereby improving the quality of the panorama image.

For example, if the difference between the first and second photography parameters is smaller than the threshold value, the terminal does not change the photography parameter, i.e., uses the current first photography parameter and then obtains the panorama image in the corresponding progressing direction [S610].

On the contrary, if the difference between the first and second photography parameters is equal to or greater than the threshold value, the terminal extracts a first photography parameter, which needs to be adjusted, and then calculates an adjustment level based on the extracted photography parameter [S612].

Thereafter, the terminal applies the adjustment level calculated based on the extracted photography parameter as a photography parameter for the first camera unit for the panorama photography and then obtains the final panorama image [S614].

Meanwhile, if the terminal moves for the panorama photography after the initial step S602, the terminal performs the step S608 periodically or continuously. Thus, the steps S612 to S614 can be performed for all the remaining panorama areas after the step S602. Alternatively, adjustment or re-adjustment can be performed based on the determination result made in the step S608.

In this case, the adjustment or re-adjustment may imply that a high dynamic range (HDR) function is applied to a corresponding area. However, the present invention is not limited to the HDR function.

In the present invention, each of the first and second photography parameter does not mean a single parameter but may include a plurality of or all photography parameters. Thus, when the adjustment is required, the terminal may preferentially perform an operation of selecting photography parameters that need to be adjusted.

For example, the terminal compares the first and second photography parameters, extracts photography parameters that need to be adjusted or have different values from the first and second photography parameters, and then compares photography parameter data of the extracted photography parameters. If a difference between the photography parameters is equal to or greater than the threshold value, the mobile terminal can apply a predetermined photography parameter level or a photography parameter level calculated in real time to the photography parameters.

Meanwhile, the adjustment based on the photography parameter difference can not only work as the solution but also minimize distortion of the panorama image.

If the panorama image is obtained by adjusting only the panorama parameters, the difference between which is equal to or greater than the threshold value, without consideration of other panorama areas, the final panorama image may look awkward. Therefore, the adjustment level should be determined by considering other panorama areas.

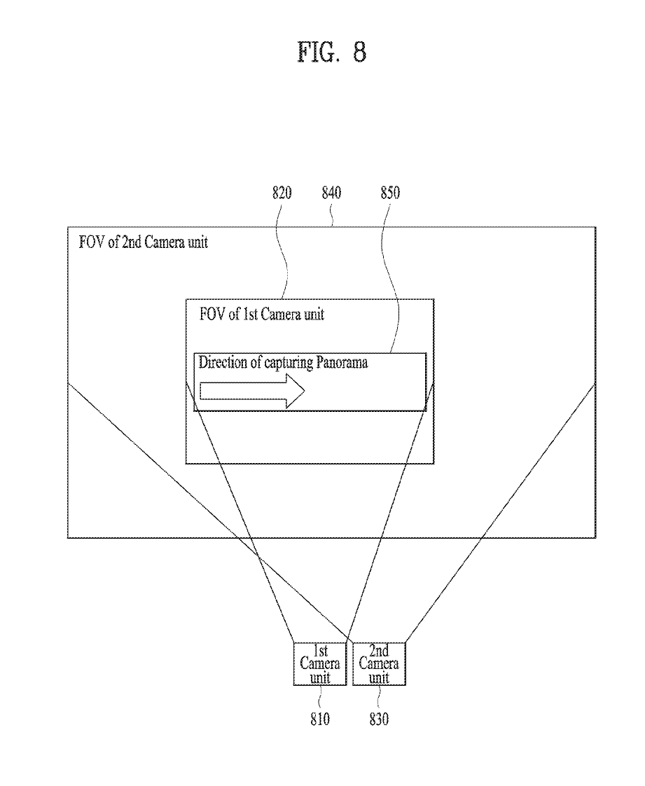

Regarding this matter, a method for processing an image obtained by the camera unit of the terminal according to the present invention will be described in detail with reference to FIGS. 8 to 10.

FIGS. 8 to 10 are diagrams for explaining a panorama photography method according to one embodiment of the present invention.

Referring to FIGS. 8 to 10, the terminal includes a first camera unit 810 and a second camera unit 830.

Specifically, FIG. 8 shows an FOV 820 of the first camera unit 810 and an FOV 840 of the second camera unit 830 when the camera units are activated. In addition, the panorama direction is assumed to be from the left to the right.

As shown in FIG. 8, the first camera unit 810 can capture an image with respect to its angle of view, i.e., the first FOV 820 and then obtain a photography parameter for the first FOV 820. On the other hand, the second camera unit 830 can obtain a photography parameter for the second FOV 840 without capturing an image with respect to its angle of view, i.e., the second FOV 840.

In this case, the first FOV 820 of the first camera unit 810 may be difference from the second FOV 840 of the second camera unit 830 as shown in FIG. 8. Although FIG. 8 shows the second FOV 840 covers a wider range including that of the first FOV 820, the present invention is not limited thereto.

Thus, if the photography parameter for the second FOV 840 is calculated using the second camera unit 830, there is no need to calculate the photography parameter for the first FOV 820. In some case, functions of the camera units can be separated such that the first camera unit 810 is used only for obtaining an image of an area corresponding to the first FOV and the second camera unit 830 is used for obtaining the photography parameter for the first or second FOV.

Meanwhile, photography parameter data related to the first FOV 820 obtained using the first camera unit 810 or photography parameter data related to the second FOV 840 obtained using the second camera unit 830 may be different from photography parameter data related to the area corresponding to the first FOV. For example, when photography parameter data related to each FOV is calculated as an average value, the photography parameter data related to the second FOV may be different from that related to the first FOV because it is calculated by reflecting a wide area compared to the first FOV.

In some embodiments, the photography parameter for the first FOV may not be initially calculated. In other words, the photography parameter for the second FOV can be used as the photography parameter for the first FOV. Particularly, when image processing due to a plurality of FOVs or a continuous FOV change is required like the panorama image, it can make an image generated based on the FOV(s) more smooth.

Alternatively, when calculating the photography parameter for the second FOV, the second camera unit 830 may calculate a photography parameter for an area that does not overlap with that of the first FOV without calculating a photography parameter for an area that overlaps with that of the first FOV. In this case, if the data on the panorama direction is received, there is no need to calculate a photography parameter for an area that is not related to the panorama direction in the area where the first and second FOVs do not overlap with each other.

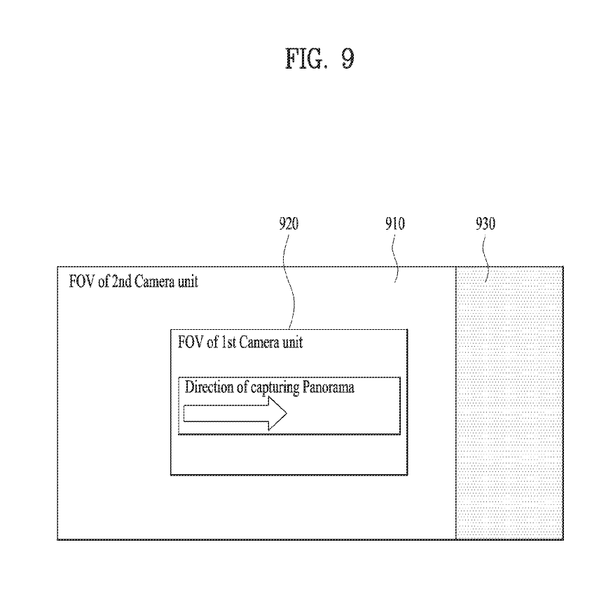

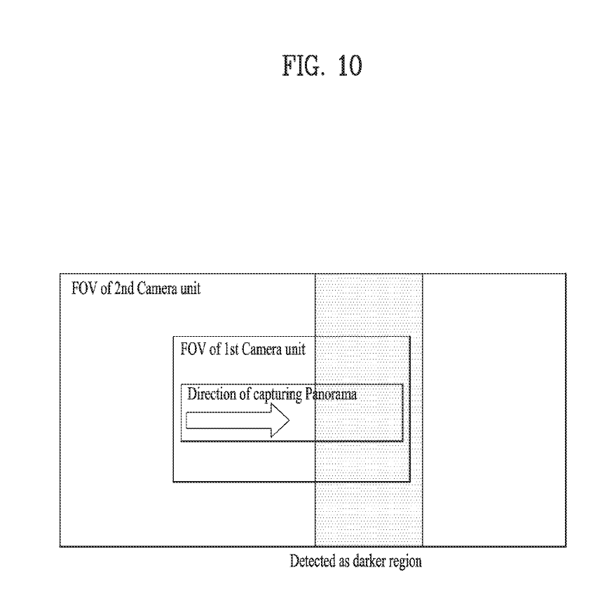

FIG. 9 shows a first FOV 910 of the first camera unit and a second FOV 920 of the second camera unit. It can be seen that the second FOV 920 of the second camera unit includes an area 930 with a photography parameter different from that of the first FOV 910, which is not included in the first FOV 901 of the first camera unit. For convenience of description, the area 930 in the second FOV 920 is referred to as a dark region.

If the dark region 930 is placed in the direction opposite to the panorama direction or it is not included in the panorama image in considering of the panorama direction, the dark region 930 can be neglected. Otherwise, the dark region 930 may degrade the quality of the final panorama image if the image is not adjusted according to the present invention.

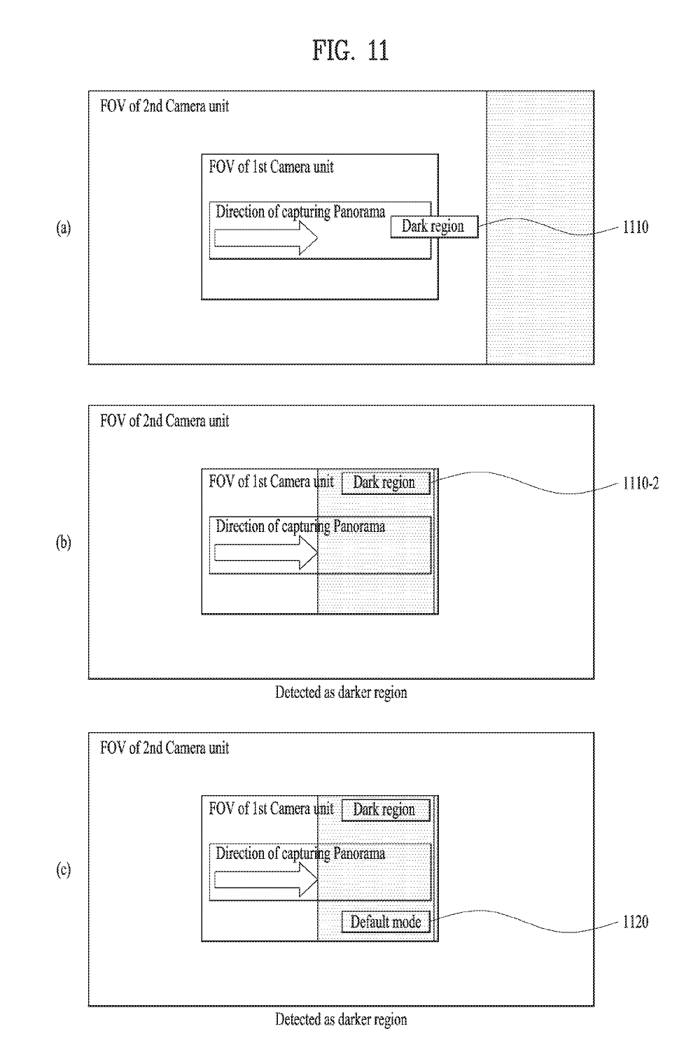

FIG. 10 shows a case in which the dark region 930, which has been included in the second FOV, is currently included in the first FOV of the first camera unit due to a movement of the terminal in the panorama direction.

In the related art, in the case shown in FIGS. 9 and 10, the photography parameter for the first FOV obtained using the first camera unit is not changed until the final panorama image is obtained. That is, the dark region shown in FIGS. 9 and 10 degrades the quality of the panorama image.

However, according to the present invention, when the dark region is present in the second FOV of the second camera unit that has an angle wider than the first FOV of the first camera unit, i.e., covers a wide area compared to the first camera unit, the dark region can be detected.

In addition, the photography parameter for the first FOV of the first camera unit can be compared with that for the second FOV of the second camera unit based on the dark regions detected by the second camera unit. Moreover, the photography parameters can be adjusted with reference to the threshold value either automatically or manually while the panorama image is captured.

Hence, according to the present invention, the final panorama image can be adjusted and thus, the image becomes more natural.

Meanwhile, referring to FIGS. 6 to 10, the dart region can be detected according to the present invention. If the detected dark region is included in the first FOV of the first camera unit, the initial photography parameter of the first camera unit is adjusted. In this case, various panorama images can be generated depending on adjustment methods. In addition, such image directing can be provided as a sub-mode of the panorama photography mode and thus, it can be performed either manually or automatically.

For example, the sub-mode or default mode of the panorama photography mode may support a function of making an image natural. In this case, if the dark region is present in the second FOV of the second camera unit, it can be displayed on a screen of the terminal.

Referring to FIG. 11(a), when the terminal moves in the panorama direction, the terminal can provide guide data 1110 for informing that the dark region, which is detected through the second camera unit, will appear soon before entry into the dark region. Such guide data 1110 is provided as shown in FIG. 11(a) to indicate a remaining time or distance until entry into the dark region. Thereafter, when the dark region appears due to the movement of the mobile terminal, the guide data 1110 shown in FIG. 11(a) can be changed as shown in FIG. 11(b) or (c).

Meanwhile, even when there is no separate guide data indicating the presence of the dark region, the detected dark region can be represented as a dotted line or in a flickering manner as shown in FIG. 11.

Referring to FIG. 11(b), guide data 1110-2 for indicating that a corresponding area is the dark region can be moved at the top of the first FOV.

Referring to FIG. 11(c), guide data (1120) for indicating a method of processing or adjusting the dark region can be further provided together with the guide data 1110-2 shown in FIG. 11(b).

Meanwhile, referring to FIGS. 11(a) to (c), if a user selects the guide data or the detected dark region after the guide data or the detected dark region is provided, the terminal can stop the panorama photography mode for a while. In this case, image data captured before the stop of the panorama photography mode can be temporarily stored in a buffer or memory. In addition, if the terminal is out of a predetermined area (not shown) for guiding the panorama photography after stopping the panorama photography mode, it does not affect the previously captured or temporarily stored panorama data.

Moreover, a different menu or function can be provided depending on the area selected to stop the panorama photography mode. For example, when the guide data 1110 of FIG. 11(a) is selected, the panorama photography mode is stopped and then, predetermined details for the panorama photography and a menu for changing an entire configuration can be provided.

Alternatively, when the guide data 1110-2 for informing the dark region shown in FIG. 11(b) is selected, the corresponding dark region can be eliminated from the panorama photography data.

Further, when the default mode 1120 shown in FIG. 11(c) is selected, a different mode can be immediately provided and image processing can also be performed based on the mode provided in real time, thereby improving user convenience.

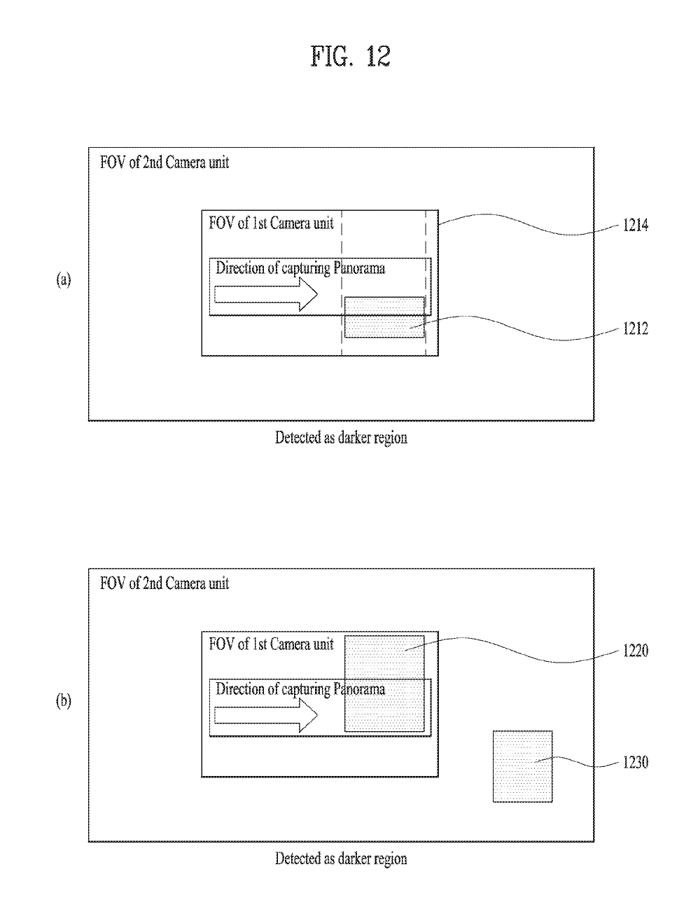

FIG. 12 shows a method of processing a person or an object (hereinafter referred to as a dark object) corresponding to the dark region.

For example, referring to FIG. 12(a), when a dark object 1212 enters the first FOV, the terminal can adjust a photography parameter for an area 1214 including the dark object 1212 as described with reference to FIG. 11. Alternatively, the terminal can adjust a photography parameter for only the corresponding dark object 1212.

It can be seen from FIG. 12(b) that two dark objects 1220 and 1230 continuously enter the first FOV. In this case, a photography parameter for the first dark object 1220 can be first adjusted and then the adjusted photography parameter for the first dark object 1220 can be applied to the second dark object 1230 as it is. However, in the case of a pre-detectable dark object, it can be newly configured based on a photography parameter that is applied or will be applied to the current position or the previous or next panorama frame.

Hereinabove, it has been described that the photography parameter is adjusted in consideration of the dark region or object in the panorama photography mode. However, according to the present invention, the photography parameter to be adjusted and the degree of adjustment can also be determined by considering not only the dark region or object but also photography parameters for the previous and/or next panorama frame.

Hereinafter, brightness is taken as an example. It is assumed that brightness of an area included in the initial first FOV is 10, brightness of the dark region is 30, and an area beyond the dark region is 40. In this case, if the brightness of the dark region is determined in the range of 10 to 30 (e.g., 20) by considering only the brightness of the area included in the initial first FOV, the brightness of the dark region may be significantly different from that of the area beyond the dark region. Thus, the brightness of the dark region should be determined in the range of 20 to 30 by considering both of the brightness of the area included in the initial first FOV and the brightness of the area beyond the dark region for smooth change in brightness of the panorama image. Alternatively, the brightness of the area included in the first FOV can be adjusted with reference to brightness of the second FOV in advance, thereby reducing brightness differences between the area included in the first FOV and other areas. In addition, the dark region or object can be changed based on this process. Moreover, selection or configuration of the dark region or object may be determined in advance or it can be changed by the user. For example, if a brightness difference between areas is equal to or greater than a threshold value, the areas may be set to the dark region or object.

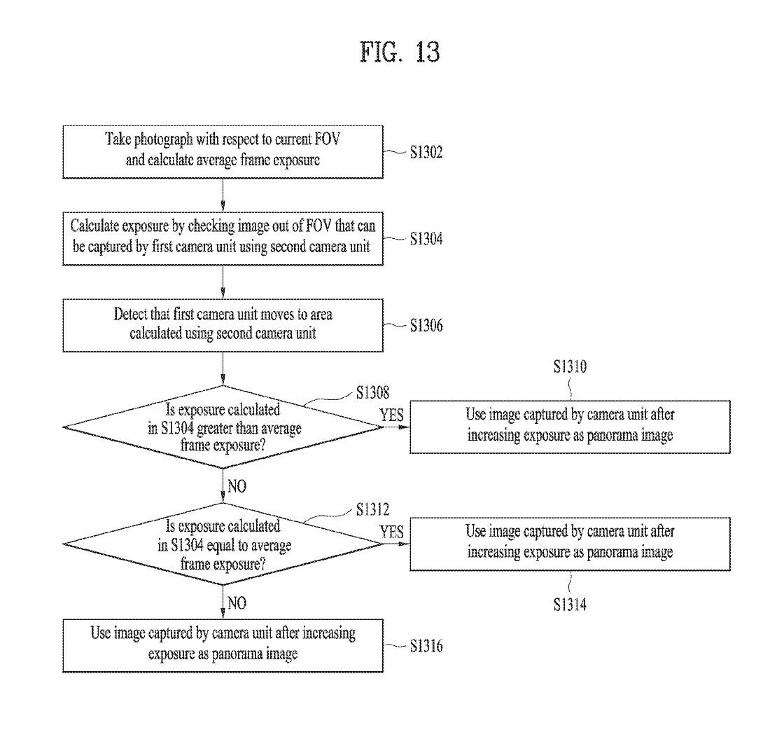

FIG. 13 is a diagram for a camera sensor data processing method for a mobile terminal according to another embodiment of the present invention.

The mobile terminal takes a photograph with respect to the current FOV. In this case, the terminal calculates an average frame exposure value with respect to the FOV [S1302].

The terminal calculates an exposure value by checking an image out of the FOV that can be captured by the first camera unit using the second camera unit [S1304].

If the terminal detects that the first camera unit moves to the area calculated using the second camera unit [S1306], the terminal determines whether the exposure value calculated in the step S1304 is greater than the average frame exposure value calculated in the step S1302 [S1308].

If it is determined that the exposure value is greater than the average frame exposure value, the terminal uses an image captured by the first camera unit by applying the HDR as the panorama image [S1310].

On the other hand, if the exposure value is smaller than the average frame exposure value, the terminal determines whether the exposure value is equal to the average frame exposure value [S1312].

If it is determined that the exposure value is equal to the average frame exposure value, the terminal uses an image captured by the first camera unit without setting a separate exposure value as the panorama image [S1314].

However, If it is determined that the exposure value is not equal to the average frame exposure value, the terminal uses an image captured by the first camera unit after increasing the exposure value as the panorama image [S1316].

In the step S1312, the case in which the exposure value is equal to the average frame exposure value may include a case in which a difference between the exposure value and the average frame exposure value is smaller than a predetermined threshold value.

According to at least one embodiment of the present invention, when functions based on a camera unit are performed, relevant parameters can be corrected or adjusted to handle an event such as a problem occurring during a photography process rapidly or in real time before acquisition of a final image/picture, thereby obtaining a more natural image/picture. In addition, using a plurality of camera units, the quality of an image/picture can be improved, an event such as a problem occurring during a photography process can be handled in real time, and a separate editing process for the image/picture can be omitted, thereby improving usability and/or efficiency of the mobile terminal. Furthermore, product reliability can be enhanced by providing an image/picture with improved quality through a mobile terminal provided with or connected to a plurality of camera units.

Although the terms used in the present specification are selected from general terms that are widely used at present while taking into consideration their functions, these terms may be replaced by other terms based on intentions of those skilled in the art, customs, or the like. Accordingly, the terms used herein should be defined based on practical meanings thereof and the whole content of this specification, rather than based on names of the terms.

The above-mentioned control method can be implemented in a program recorded medium as computer-readable codes. The computer-readable media may include all kinds of recording devices in which data readable by a computer system are stored. The computer-readable media may include HDD (Hard Disk Drive), SSD (Solid State Disk), SDD (Silicon Disk Drive), ROM, RAM, CD-ROM, magnetic tapes, floppy disks, optical data storage devices, and the like for example and also include carrier-wave type implementations (e.g., transmission via Internet). Further, the computer may include the controller of the wearable device. Thus, the above embodiments are to be considered in all respects as illustrative and not restrictive. The scope of the invention should be determined by reasonable interpretation of the appended claims and all change which comes within the equivalent scope of the invention are included in the scope of the invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A terminal comprising:
a first camera having a first angle of view;
a second camera having a second angle of view; and
a controller configured to:
obtain image data from the first camera based on a first photography parameter for a first field of view (FOV) of the first camera;
obtain a second photography parameter for a second FOV of the second camera;
change the first photography parameter based on a comparison result of the first photography parameter and the second photography parameter; and
continue to obtain the image data from the first camera based on the change in the first photography parameter.

2. The terminal of claim 1, wherein when a panorama photography mode is activated, the controller is further configured to:
change the first photography parameter by comparing the first photography parameter and the second photography parameter.

3. The mobile terminal of claim 1, wherein the controller is further configured to:
change the first photography parameter based on the second photography parameter, when the comparison result is such that a difference between the first photography parameter and the second photography parameter is greater than a threshold value.

4. The terminal of claim 1, wherein the first photography parameter comprises an average value for the first FOV.

5. The terminal of claim 2, wherein the controller is further configured to:
detect a dark region or object based on the second photography parameter obtained through the second camera.

6. The terminal of claim 5, wherein the controller is further configured to:
provide first guide data indicating presence of the dark region or object, and provide second guide data for the changed value of the first photography parameter before or after the dark region or object enters the first FOV of the first camera, when the detected dark region or object is placed in a panorama direction in the panorama photography mode.

7. The terminal of claim 3, wherein the controller is further configured to:
consider a photography parameter of a frame before or after a frame including the dark region or object together, when the first photography parameter is changed.

8. The terminal of claim 1, wherein the first angle of view is different from the second angle of view, and wherein the first angle of view is narrow or standard and the second angle of view is wide.

9. The terminal of claim 1, wherein each of the first photography parameter and the second photography parameter comprises at least one of an exposure value, a shutter speed, or zoom-in/zoom-out data.

10. A terminal comprising:
a first camera having a first angle of view;
a second camera having a second angle of view; and
a controller configured to:
obtain first data on a first field of view (FOV) from the first angle of view of the first camera;
obtain second data on a second FOV from the second angle of view of the second camera;
compare the first data with the second data; and
change a photography parameter for a portion of the first data and the second data having different data when obtaining an image using the first camera or the second camera.

11. A method of controlling a terminal, comprising:
obtaining image data from a first camera based on a first photography parameter for a first field of view (FOV) of the first camera;
obtaining a second photography parameter for a second FOV of the second camera;
changing the first photography parameter based on a comparison result of the first photography parameter and the second photography parameter; and
continuing obtaining the image data from the first camera based on the change in the first photography parameter.

12. The method of claim 11, wherein when a panorama photography mode is activated, the method further comprises:
changing the first photography parameter by comparing the first photography parameter and the second photography parameter.

13. The method of claim 11, further comprising:
changing the first photography parameter based on the second photography parameter, when the comparison result is such that a difference between the first photography parameter and the second photography parameter is greater than a threshold value.

14. The method of claim 11, wherein the first photography parameter comprises an average value for the first FOV.

15. The method of claim 12, further comprising:
detecting a dark region or object based on the second photography parameter obtained through the second camera.

16. The method of claim 15, further comprising:
providing first guide data indicating presence of the dark region or object, and providing second guide data for the changed value of the first photography parameter before or after the dark region or object enters the first FOV of the first camera, when the detected dark region or object is placed in a panorama direction in the panorama photography mode.

17. The method of claim 13, further comprising:
considering a photography parameter of a frame before or after a frame including the dark region or object together, when the first photography parameter is changed.

18. The method of claim 11, wherein the first angle of view is different from the second angle of view, and wherein the first angle of view is narrow or standard and the second angle of view is wide.

19. The method of claim 11, wherein each of the first photography parameter and the second photography parameter comprises at least one of an exposure value, a shutter speed, or zoom-in/zoom-out data.

20. A method of controlling a terminal, comprising:
obtaining first data on a first field of view (FOV) from a first angle of view of a first camera;
obtaining second data on a second FOV from a second angle of view of a second camera;
comparing the first data with the second data; and
changing a photography parameter for a portion of the first data and the second data having different data when obtaining an image using the first camera or the second camera.
